(19) United States
(12) Patent Application Publication
(10) Pub. No.: US 2017/0227472 A1
(43) Pub. Date: Aug. 10, 2017

(54) AN OPTICAL INSPECTION SYSTEM

(71) Applicant: William Colton, Worksop (GB)

(72) Inventor: William Colton, Worksop (GB)

(21) Appl. No.: 15/501,845

(22) PCT Filed: Aug. 5, 2015
(86) PCT No.: PCT/GB2015/052271

§ 371 Date: Feb. 5, 2017

(30) Foreign Application Priority Data
Aug. 5, 2014 (GB) 1413878.8

(51) Int. Cl. G01N 21/90; B29C 49/06; B29C 45/76; B29C 49/78

(52) U.S. Cl. CPC G01N 21/9081; B29C 49/78; B29C 49/061; B29C 45/7686; G01N 2021/8455

(57) ABSTRACT

A preform optical inspection system includes a plurality of carrier units, each mounted on a respective lane conveyor for receiving preforms from an injection molding device and an optical inspection unit. The optical inspection unit is able to transverse movement across the lane conveyors and the carrier units are able to pass though the optical inspection unit.

### FIELD OF THE INVENTION

The invention relates to a preform optical inspection system and a method of operating the same.

### BACKGROUND TO THE INVENTION

Injection Mould Machines are commonly used to inject plastic into an array of dies (cavities), forming multiple parts each time the press cycles. Preforms which are later blown into bottles are an example of products which can be produced using such machines. The cycle of the press is usually in the following order, press closes, plastic is injected into each die (cavity) forming the parts, the press then opens leaving a gap between the mould halves where the parts are ejected.

At the point of ejection parts are often removed from the mould by a robot tool which slides between the two halves of the mould receiving the preforms into an array of tubes which matches the exact layout of the mould.

The robot tool maintains the sequence of parts in the same order as in the mould. The parts are also still orientated in the same manner relative to each other.

After the robot has received the preforms from the mould it retracts back out from between the mould halves and drops the parts onto a conveyor where the sequence and consistent orientation of the parts becomes jumbled and therefore lost. The conveyor then transports the parts to a storage container.

The robot tool provides many advantages such as additional cooling to ensure the intended shape of the preforms is maintained and can assist with reducing cycle time. The injection mould process of preforms has a multitude of potential quality issues such as damaged gates, black specs, short shots and colour variation. Defective preforms can lead to many issues further down the process at the blow moulding and container filling stages.

One example would be an undetected short shot. A short shot is when insufficient material has been put into a cavity. In this case the seal between the container and the closure will not be sufficient or consistent, leading to a leaking bottle or the spoiling of the goods held within them. Finding these bottles within pallets of finished goods, removing them from supermarket shelves or the down time due to jam ups at the filler or blow moulding machine processes, have significant cost implications especially if the frequency of these bad parts is intermittent. This has lead to optical camera units being used after the injection moulding process to ensure preforms meet specification. Typically these optical inspection systems are used in one of two formats.

The first is directly after the conveyor the robot tool drops the preform onto. In this case the preforms are fed from the injection machine into the inspection unit without the use of storage containers.

The second is completely separate from the injection machine using a storage container dispensing system to feed the inspection unit.

In both formats the preforms must be orientated before they can be inspected, this is achieved by several proven techniques, examples of these include rollers and bowl feeders.

Both techniques mentioned have known issues with maintaining a smooth flow of parts. The problem is particularly common on preforms which are capable of nesting inside each other due to their shape, causing the preform feed to jam. These problems are normally overcome by using ever longer rollers (2-6 meters are common), large diameter bowl feeders, or ejection systems to remove parts which are jammed and preventing a smooth flow. These systems require large amounts of floor space and therefore may not be suitable to fit within an existing factory layout of multiple injection machines.

Any inspection system which receives preforms which have been jumbled up and therefore lost the original mould sequence have to use less than optimum techniques to identify which exact die (cavity) the preform was moulded in.

One known technique is to optically inspect the cavity identification numbers embossed on the side of the preform normally located just above the neck support ring.

Alphanumeric recognition software can then translate the pixelated shapes into digital letters and numbers. Due to the small size of the shapes and the similarity of certain letters and numbers mistakes are possible leading to the wrong cavity being identified.

To address the issue of incorrect cavity identification, methods have been developed to maintain the sequence, organisation and orientation of the preforms from the mould and or robot tool prior to the optical inspection.

U.S. Pat. No. 6,878,316 (Cochran et el; Pressco Technology Inc.) discloses a system of receiving preforms from a moulding machine comprising of a plurality of tubes in an array matching the robot tool. The preforms are dropped from the robot tool and then slide down the tubes under the force of gravity and friction, later falling into a belt system still in sequence. These belts then transport the parts to the inspection point.

The principle of maintaining the array sequence offers significant advantages for accurately capturing data for each specific cavity. This data can be fed back to the injection machine, analysed and then used to alter the injection process. By ejecting intermitted faults and then autonomously adjusting the injection process to stop the faulty parts being produced the minimum opportunities for defect parts to be fed into the blow moulding process is achieved. This has significant cost and energy implications as the PET resin used is high cost and used in very large volumes. If a problem is intermittent and goes undetected for 24 hours, millions of parts could be affected and may have to be scrapped if the defective parts cannot be removed.

The choice of using tubes and relying on gravity to deliver the preforms from the robot tool to the inspection point is however not without potential issues. Preforms may become jammed within the tubes or on entry to the belts, if a preform did jam the cavity sequence could potentially be lost or result in the injection machine stopping.

Feed reliability is critical in the process because if preforms jam in the tubes or belts which feed the inspection system and create a backlog of parts, the injection mould machine could be forced to stop. If the injection machine stops, human intervention is then required to clear the jam and as a quality precaution it is common to scrap several cycles of parts following a restart, wasting expensive material.

This invention is intended to solve the problems associated with preform feed jams both due to re-orientating the parts and mechanically moving and holding the parts. The invention also addresses the issue of floor space by offering a solution which can generally fit inside the existing footprint of the injection mould machine and robot tool. Cavity identification is also considerably more repeatable as it does not rely on gravity and instead physically controls each preform during the transfer process.

The part stability of the gripping technique used further ensures the optical inspection unit can take consistent images of every preform.

### SUMMARY OF THE INVENTION

Accordingly, the present invention is directed to a preform optical inspection system comprising:
a plurality of carrier units, each mounted on a respective lane conveyor and adapted to receive preforms from an injection moulding device; and an optical inspection unit;
wherein the optical inspection unit is capable of transverse movement relative to the lane conveyors and the carrier units are able to pass through the optical inspection unit.

The preforms are received from an injection moulding into carrier units that then transport the preforms along a lane conveyor through an optical inspection unit. The use of a plurality of carriers and an optical inspection unit that traverses the lane conveyors provides a quick and efficient, yet cost-effective, inspection system. Additionally, the use of a plurality of lane conveyors reduces the length of the system, thereby making the optical inspection system more compact.

The preforms are held either in the tool or in the carrier units. Therefore, they are not gravity fed. This results in the preforms being less likely to move in a random and unpredictable way, thus reducing the risk of jamming due to misaligned preforms in the system. The orientation and position of the preforms is controlled, thereby resulting in a more predictable system.

Advantageously, the system is provided with a tool for receiving preforms from an injection moulding device and delivering them to the carrier units. The reduces the risk of the preforms falling unpredictably due to gravity.

Preferably, the lane conveyors are substantially linear and, more preferably, the lane conveyors are substantially parallel to one another. By keeping the lane conveyors linear and substantially parallel, the system can operate quickly and reliably. Additionally, the optical inspection unit can inspect the preforms at a position that is approximately the same for all of the preforms, thus making locating the preform on the carrier unit more predictable. Whilst it is envisaged that one might wish to employ a curved track, for example to save space, such a system may complicate the geometry and distances and creates more room for errors.

Advantageously, the optical inspection unit moves substantially perpendicularly to the lane conveyors. Whilst the optical inspection unit may move at an angle to the lane conveyors, it is more practical and easier to have the optical inspection unit moving substantially perpendicularly to the lane conveyors.

In one embodiment, the carrier units comprise a plurality of grippers for receiving and holding the preforms therein. The use of mechanical grippers allows for the preforms to be held firmly within the carrier units, with each preform held by an individual gripper. The grippers of the carrier unit may be individually activated to accept, hold and release preforms independently of the other grippers on the carrier unit. The grippers employ actuators to grip and release a preform, employing either electric gripping jaws or pneumatic gripping jaws, which are activated by electric command signals. Other mechanical solutions include cams or springs which become activated according to the position of the gripper along the system. The gripper may employ different mechanisms depending upon the requirements.

In one arrangement, the carrier units and their respective lane conveyors are attached to a vertical conveyor which is height-wise adjustable so as to permit them to be raised towards the tool to receive the preforms and lowered therefrom. By providing the carrier units with vertical adjustment, the system is able to receive the preforms from the injection moulding device without the risk of them dropping unsupported, which may result in damage or misalignment.

It is preferable that the system further comprises a chute positioned beneath the end of the lane conveyors furthest from the tool to receive preforms from the carrier units once they have been inspected. More preferably, the chute has a first conduit and a second conduit to direct the inspected preforms accordingly. The use of a chute and, preferably, a two-conduit chute allows the preforms to be sorted and sent on to a different part of the bottle making process. Those preforms that are not up to the required quality standard are sent through a first conduit in the chute and may be disposed of or recycled, and those that meet the quality standards are sent through a second conduit to be processed further.

It is advantageous that the system further comprises a monitoring device to monitor the position of each carrier unit and that the monitoring device comprises a system selected from a group comprising: a servomotor; an encoder; a camera; and a plurality of detectable items positioned along the length of the carrier units and a detector mounted adjacent the lane conveyor. Sensors may be employed on the carrier units, the lane conveyors and/or the optical inspection unit. The location of the sensors may be varied according to the requirements, provided the location of the carrier unit is known. Likewise other tracking and/or locating methods may be employed.

It is useful to know the position of each carrier so as to determine the preform that is being inspected at any particular time. As the carrier units may be employed to hold the preforms in an arrangement reflecting their position in the injection moulding device, one can equate a location on a particular carrier unit with a cavity in the tool of the injection moulding device. As such, if preforms that are held at a particular position on one of the carrier units frequently have a defect, the corresponding cavity in the tool of the injection moulding device can be inspected. This is achieved by closely monitoring the position of the carrier units as they pass through the optical inspection unit, knowing the size of the preforms and their position on the carrier units. By monitoring this one can identify the position of any defective preforms. Additionally, knowing the location of defective or substandard preforms allows the system to correctly identify those preforms that need to be disposed of or recycled and a release mechanism in the correct location on the carrier unit can be operated at the appropriate time.

The invention extends to a method of optically inspecting a plurality of preforms, comprising the steps of:
providing a plurality of carrier units each connected to a respective lane conveyor, the carrier units adjacent an injection moulding device, the injection moulding device adapted to dispense a plurality of preforms in a two-dimensional array;
providing an optical inspection unit adjacent the lane conveyors;
receiving the preforms from the injection moulding device and transferring the preforms into the carrier units;
moving a first of the carrier units along its respective lane conveyor and passing it through the optical inspection unit;
moving the optical inspection unit to a second lane conveyor and passing a second of the carrier units therethrough;
once the preforms have been inspected, ejecting a first group of preforms from the carrier units; and
ejecting a second group of preforms from the carrier units.

The preforms are received in a predetermined orientation and are tracked to monitor their position during the inspection process. As a result, the position of each preform from each mould cavity is known throughout the inspection process. As an example, the preform from cavity 1 of the injection moulding device is always held in the same position relative to the preform from cavity 2 of the injection moulding device. Similarly, cavity 1 is always dispensed and inspected in the same position relative to cavity 3. This means that even if cavity 2 is turned off, cavities 1 and 3 are still held in the same positions, as if cavity 2 was operating as normal.

Preferably, the lane conveyors are linear and substantially parallel with one another and the optical inspection unit moves substantially perpendicular to the lane conveyors. This provides a system that is readily maintainable and the geometry makes the system simpler.

Advantageously, either: the preforms are received directly in the carrier units from the injection moulding device; or the preforms are received in the carrier units via a tool which maintains the two-dimensional array created by the injection moulding device into the adjacent carrier units. Whilst the preforms may be pass directly into the carrier units of the present invention, as the preforms are often formed horizontally, it may be useful to employ a tool to take the preforms from the injection moulding device, rotate them so that they are substantially vertical and allow them to pass into the carrier units. Not only does this reduce the need for the carrier units or the injection moulding machine to rotate, it also reduces the time required between moulding the preforms and being ready for the injection moulding device to mould further preforms.

It is preferable that the method further comprises monitoring of the position of the carrier units on its respective lane conveyor to track when each preform passes through the optical inspection unit in order to identify the preform of the two-dimensional array being inspected. This allows the preform to be identified in the carrier unit so that it can be located and distributed according to the quality assessment.

In an advantageous arrangement, the result of the optical inspection of each preform is logged and one of the groups of preforms ejected from the carrier units comprises those preforms that have passed predetermined inspection criteria and the other group of preforms ejected from the carrier units comprises those pre-forms that fail to pass the predetermined inspection criteria. The results of the optical inspection dictate those preforms that are to be disposed of and those that can pass through to the next stage of the production system. Those to be disposed of are put into one group and those that are to be further processed are put into a different group. Subsequently, the preforms are released from the carrier unit in those groupings.

In one arrangement, data from the optical inspection unit is recorded during the optical inspection of each preform and that data is transferred to an injection moulding device control system, and wherein the control system adjusts process parameters based on the data received to correct any faults in the preform. By providing data from the optical inspection unit to a central control system, the operating parameters of one or more cavities in the injection moulding device may be adapted to adjust the characteristics of the preform or to stop use of a particular cavity. This allows for ‘real-time’ adjustments to be made to the system in order to increase the likelihood of a preform passing the quality inspection.

### BRIEF DESCRIPTION OF THE DRAWINGS

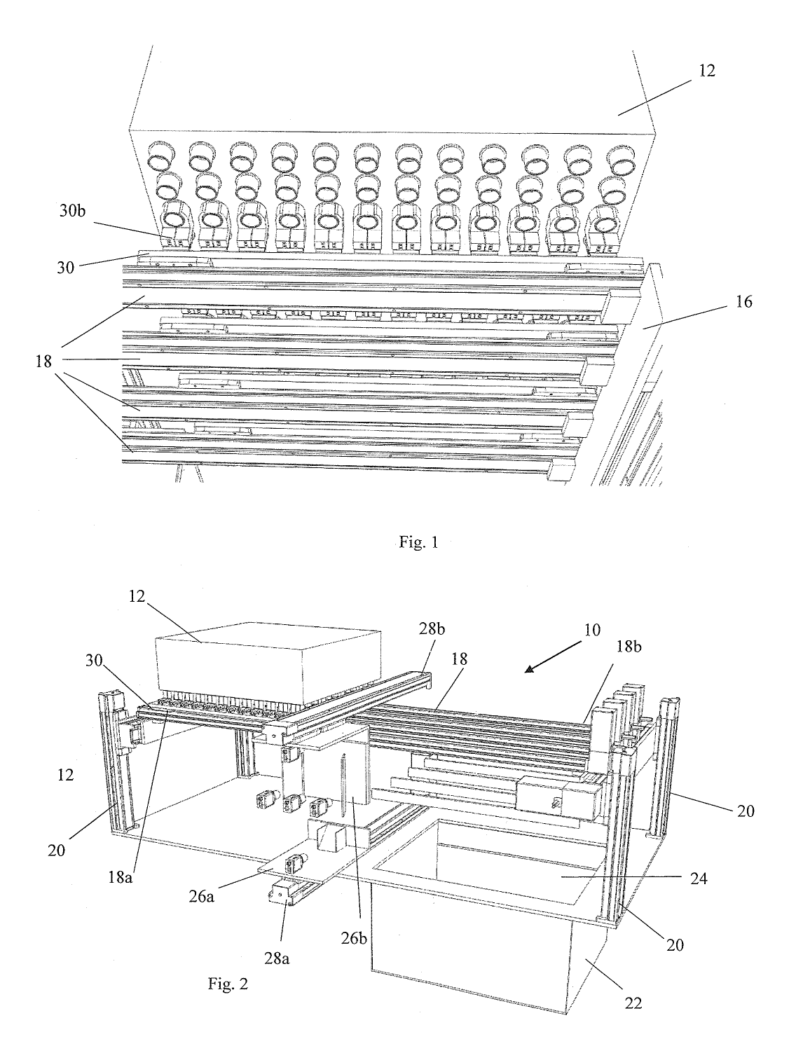

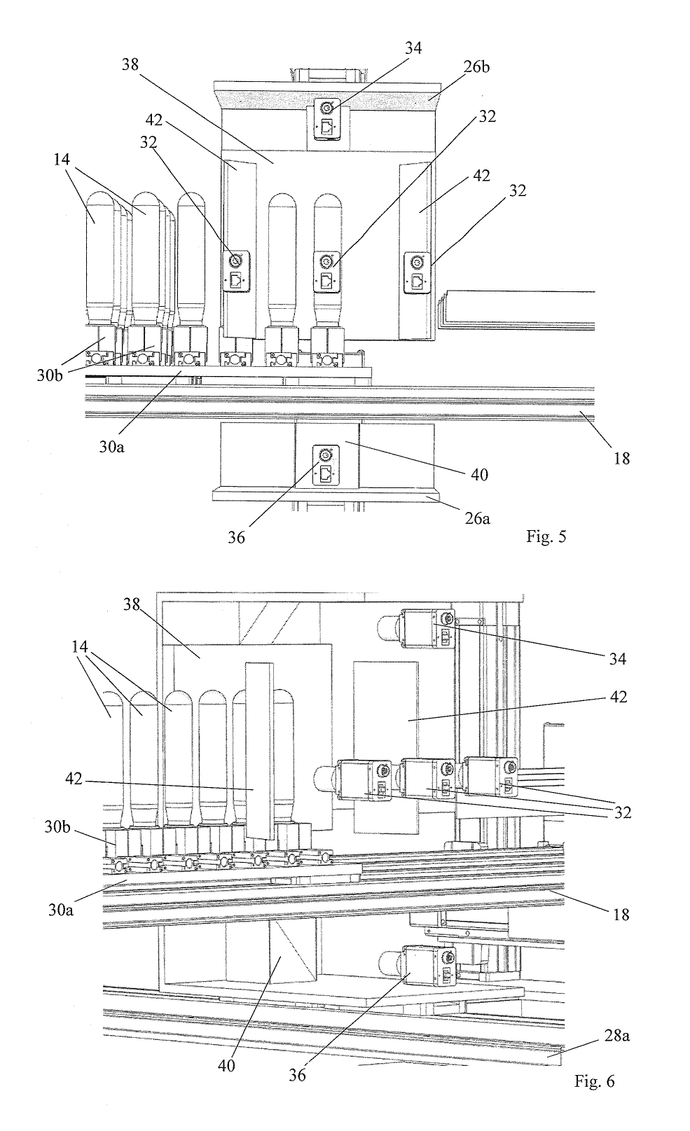

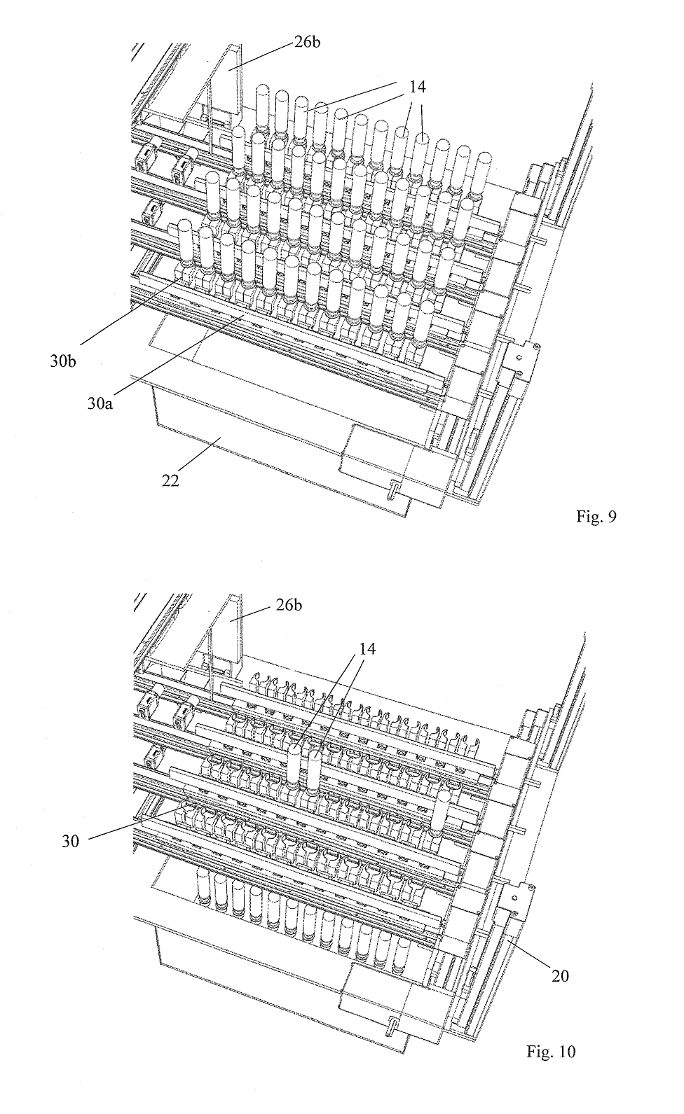

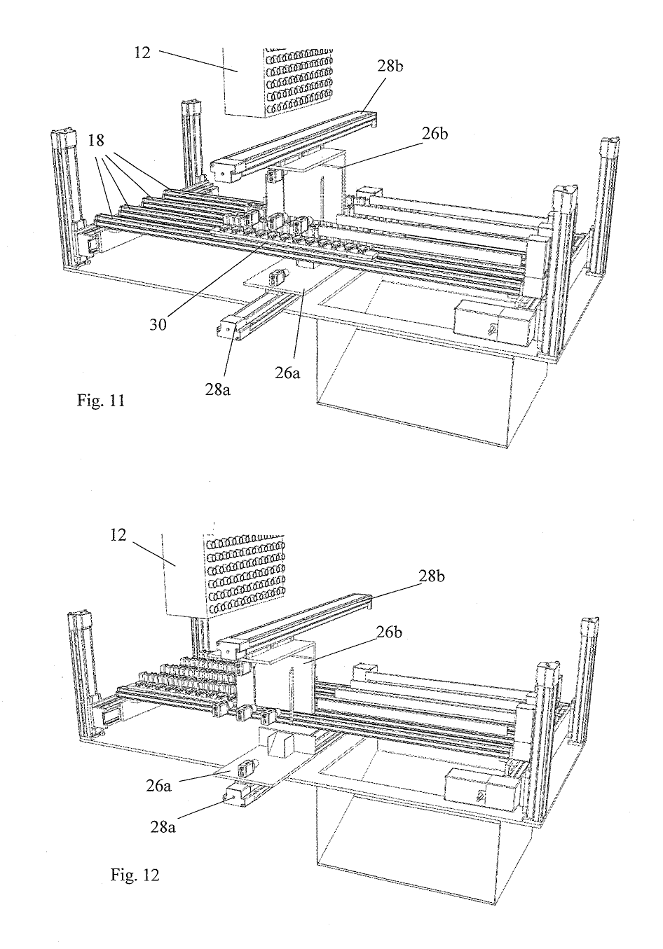

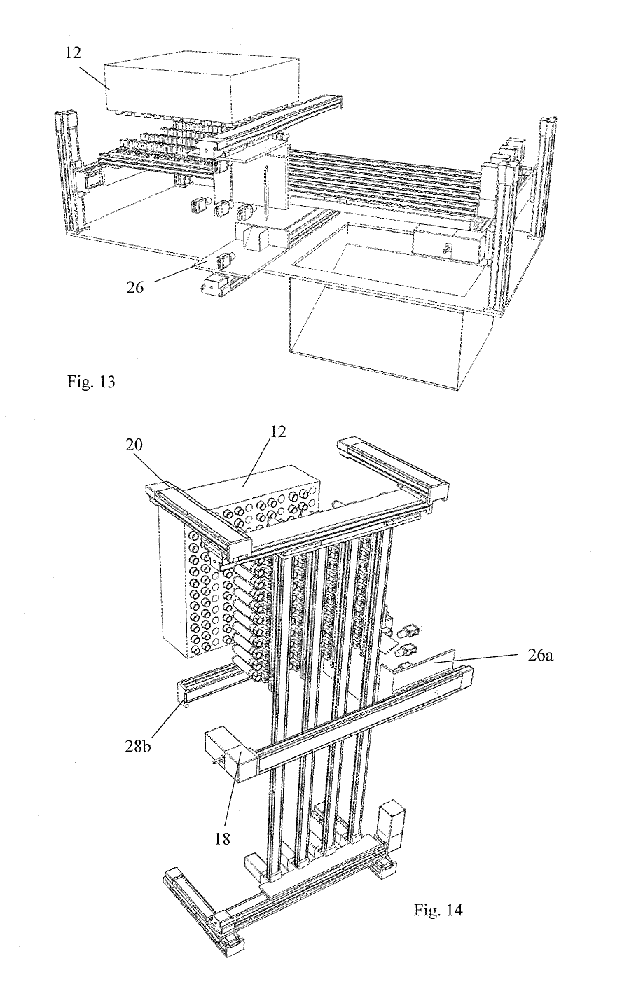

An embodiment of the invention will now be described, by way of example only, and with reference to the accompanying drawings, in which FIGS. 1 to 17 are drawings showing an embodiment of the present invention and various stages through the preform inspection process.

### DETAILED DESCRIPTION OF EXEMPLARY EMBODIMENTS

FIGS. 1 to 17 show a system 10 comprising a tool 12 adapted for receiving preforms 14 from an injection moulding device (not shown). The tool 12 is arranged above a conveyor system 16 that comprises a plurality of lane conveyors 18. The conveyor system 16 has stanchions 20 that allow the conveyor system 16 to be moved vertically up and down, relative to the tool 12. The conveyor system 16 is also able to be moved horizontally in the direction substantially perpendicular to the lane conveyors 18.

The lane conveyors 18 of the conveyor system 16 are arranged substantially in parallel and comprise a first end 18a positioned underneath the tool 12 and they extend away from the first end 18a to a second end 18b.

The second end 18b of the lane conveyors is positioned above a distribution conduit 22. The distribution conduit 22 has an open top and within the distribution conduit 22 is a moveable directing partition 24 that has a first position and a second position.

Along the length of the lane conveyors 18 is an optical inspection unit 26, which is arranged independently of the conveyor system 16, that is, it does not move vertically with the conveyor system 16. The optical inspection unit 26 comprises a lower portion 26a and an upper portion 26b, both of which are mounted on respective tracks 28a and 28b. The tracks 28 extend substantially perpendicularly across the lane conveyors 18 respectively below and above the lane conveyors 18 and they reach across all of the lane conveyors 18. The upper portion of the optical inspection unit 26b and the lower portion of the optical inspection unit 26a are linked so that they both move along the tracks at the same rate, thereby keeping in line with one another at all times. The optical inspection unit 26 comprises a plurality of cameras and mirrors arranged in such a manner that they are able to optically inspect a preform passing therewithin.

Carrier units 30 are mounted on each of the lane conveyors 18, each carrier unit 30 comprise a mounting unit 30a that is provided with a plurality of preform receiving grippers 30b. The grippers 30b are individually operable and can be opened and closed so as to be able to receive and grip a preform and release it therefrom.

In use, the tool 12 receives a two-dimensional array of preforms 14 form the injection moulding machine. The tool 12 is sized and shaped so that the preforms 14 are received in the tool 12 in the same positions as they are dispensed from the injection moulding device. For example, the injection moulding device may comprise forty-eight (48) cavities and the tool is able to hold one-hundred-and-forty-four (144) cavities (12 rows and 12 columns), which equates to three runs of the injection moulding device. Taking one row of the injection moulding device cavities in the x-direction and labelling these numerically, and taking the cavities in the tool 12 and labelling those alphabetically, the preforms are held in the tool with the arrangement A1, B1, C1, D2, E2, F2, G3, H3, 13, J4, K4, L4. This results in the tool being filled with three preforms from cavity 1 of the injection moulding device, then three preforms from cavity 2 of the injection moulding device and so on. Consequently, the spacing between each cycle of preforms is constant: A1 is produced in the same cycle as D2, G3 and J4; B1 is produced in the same cycle as E2, H3 and K4; and C1 is produced in the same cycle as F2, I3 and L4. Therefore, the position of each preform 14 ejected from the injection moulding device is reflected in the tool 12. Whilst in the tool 12, the preforms 14 begin to cool down post-mould process.

As shown in FIG. 2, the tool 12 rotates 90 degrees so that the apertures in the tool 12 are facing downwards. At the same time, all of the preforms held therein are rotated within the tool 12 and their positions in the array, relative to the other preforms is maintained. The conveyor system 16 is raised to meet the tool 12 and selected rows of the preforms contained in the tool 12 are removed from the tool 12 using the grippers 30b of the carrier units 30 and they are then held within the carrier units 30 by the grippers 30b. The grippers 30b are closed about the neck of the preform 14 by means of a series of actuators and the preform is held firmly within the carrier unit gripper 30b. Rows of the two-dimensional array of the tool are thus reflected in the carrier units 14, with the four of the twelve rows of twelve preforms 14 from the tool 12 being held in respective carrier units 30. Thus, each carrier unit 30 is provided with twelve preforms 14 and their position in the carrier units 30 is related to the cavity of the injection moulding device from which they originated. Once the preforms 14 are loaded onto the carrier units 30, the conveyor system 16 is lowered back down. The lowering of the conveyor system 16 aligns the lane conveyors 18 with the optical inspection unit 26.

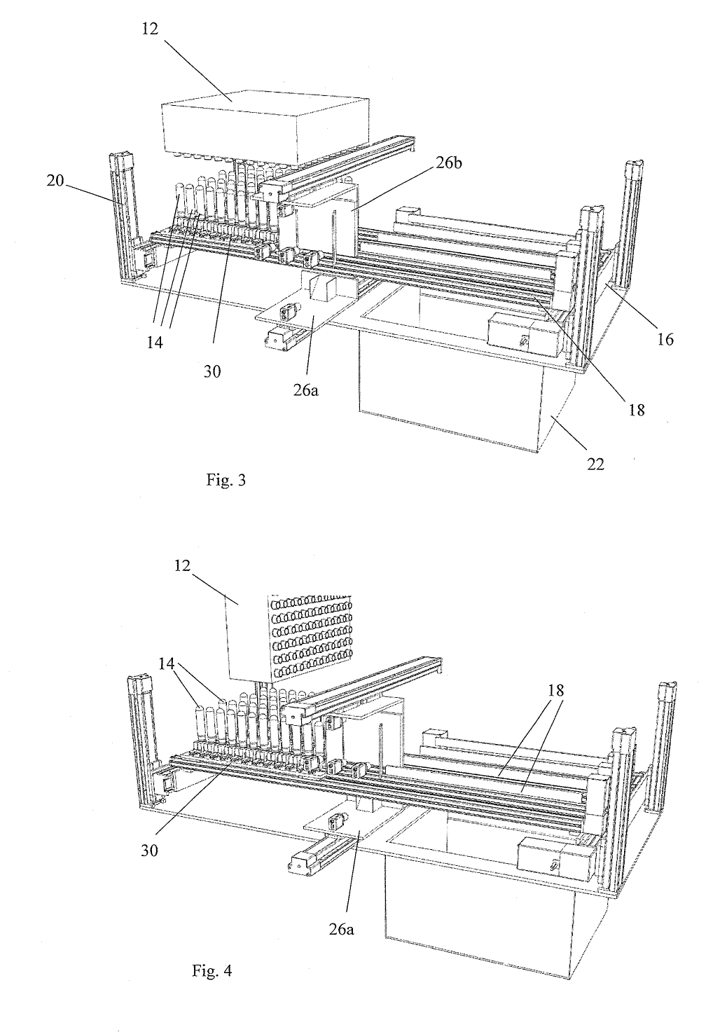

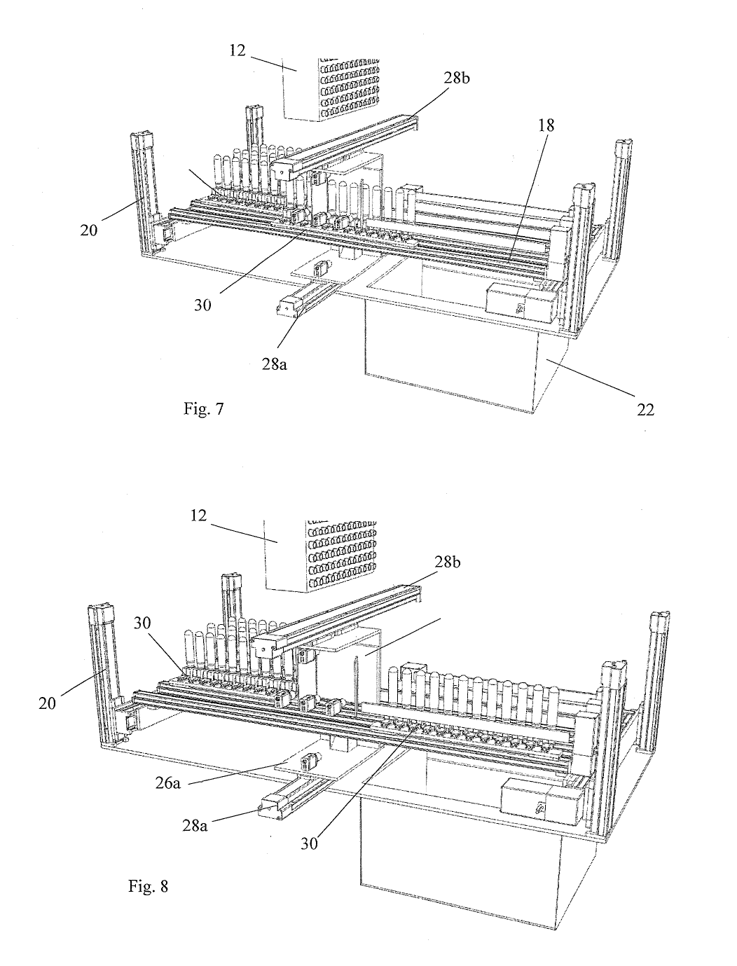

Once the preforms 14 are within the carrier units 30, the optical inspection process can begin. The optical inspection unit 26 is arranged such that the lower part 26a is positioned below a first of the lane conveyors 18 and the upper part of the optical inspection unit is positioned above the first of the lane conveyors 18, as shown in FIG. 3. The first carrier unit 30 on the first lane conveyor 18 passes from the first end of the conveyor 18a to the second end of the conveyor 18b, passing through the optical inspection unit 26 (FIG. 7). The position of the carrier unit 30 is tracked as it passes along the conveyor 18 so that the position of each of the preforms 14 held within the carrier unit 30 is known at any time. As a result, from knowing the position of each carrier unit 30 and the dimensions of the preforms and the distance between the grippers 30b, the system can tell which preform is being inspected by the optical inspection unit 26 at any time.

As the carrier unit 30 passes through the optical inspection unit 26, a series of body cameras 32, a base camera 34 and a neck camera 36 are triggered, along with a backlight 38, which is used to illuminate the body of the preform 14 and an on axis light 40, which illuminates the neck and base of the preform 14. The optical inspection unit 26 further comprises 45 degree mirrors to reflect the base of the preform into the base camera 34. Similarly, panel mirrors 42 are used to reflect the body of the preform into the left and right body cameras 32. The optical inspection unit 26 forwards the information to the central control system.

Once the first carrier unit 30 has passed through the optical inspection unit 26, the optical inspection unit 26 is moved perpendicularly across to the second lane conveyor 18, as shown in FIG. 4. The first carrier unit 30 waits at the second end of its conveyor. The second carrier unit 18 is then moved from the first end 18a of the respective lane conveyor 18 to the other end 18b, passing through the optical inspection unit 26 as it moves along the conveyor 18 (FIG. 8). Again, the optical inspection unit 26 analyses each preform as it passes through the optical inspection unit 26 and the data is forwarded to the central control system.

Once the second carrier unit 30 has been optically inspected, the optical inspection unit 26 is moved into position for inspecting the preforms held by the third carrier unit 30, and the optical inspection continues for each lane conveyor 18 and respective carrier unit 30.

Once all of the carrier units 30 have passed through the optical inspection unit 26, the carrier units are all positioned at the second end 18b of each respective conveyor 18, above the distribution conduit 22. The central control system analyses the information received from the optical inspection unit 26 and the preforms 14 are arranged into two groups: a first group of those preforms that have reached the predetermined quality levels; and a second group of preforms 14 that have not reached the required standards.

For those preforms in the first group, the grippers 30b are opened and the preforms are released. Under the influence of gravity, the preforms 14 that have been released fall into the distribution conduit 22 below the carrier units 30, as shown in FIG. 10. These preforms 14 are then passed down the production line. Once the first group of preforms 14 are clear of the distribution conduit 22, the directing partition 24 is moved from its first position to its second position and the second group of preforms 14, which are still held within the grippers 30b, are released from the grippers 30b (by opening the grippers 30b) into the distribution conduit 22. The second group of preforms are then recycled. Due to the independent operation of the grippers 30b, the groups of inspected preforms 14 can be released at different times.

Once the preforms 14 have all been released from the carrier units 30, the carrier units 30 return to the first end 18a of the respective conveyors 18, ready for the next batch of preforms 14, as seen in FIG. 12. Likewise, the optical inspection unit 26 prepares itself for the next inspection process. Preferably, the optical inspection unit 26 returns to the first lane conveyor 18, however, it may work backwards from the carrier unit 30 that was previously inspected last to the carrier unit previously inspected first. In the latter, the system notes the return motion and monitors the inspection process and position of the carriers accordingly.

Once the carrier units 30 are arranged at the first end 18a of their respective conveyors 18, the conveyor system 16 is moved horizontally to the next row of preforms in the tool 12.

The conveyor system 16 is raised up to collect another four rows of preforms 14 from the tool 12, the conveyor system is lowered and the inspection process begins again. Again, each carrier unit 30 passes through the optical inspection unit 26. Whilst the carrier units 30 are being inspected, the tool 12 returns to the injection moulding device to collect further preforms in the, now empty, recesses.

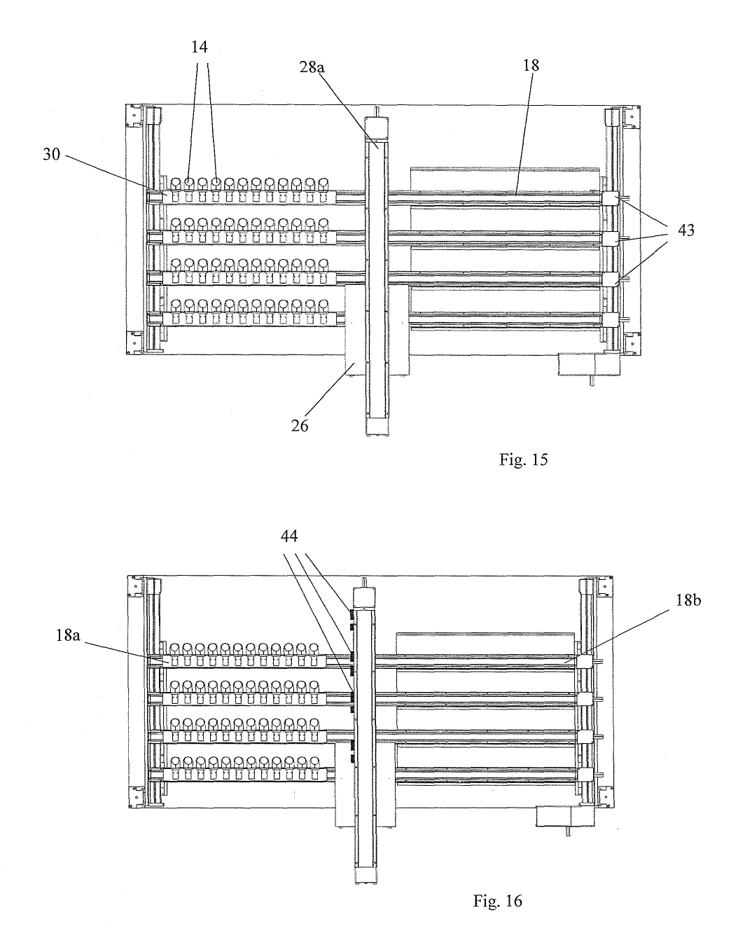

FIG. 15 shows the position of motors 43 for controlling the lane conveyors 18. The motor may be in the form of a servo motor in order to monitor the position of the carrier unit 30 on the lane conveyor 18.

FIG. 16 shows an embodiment comprising sensors 44 arranged to monitor movement of the carrier units 30.

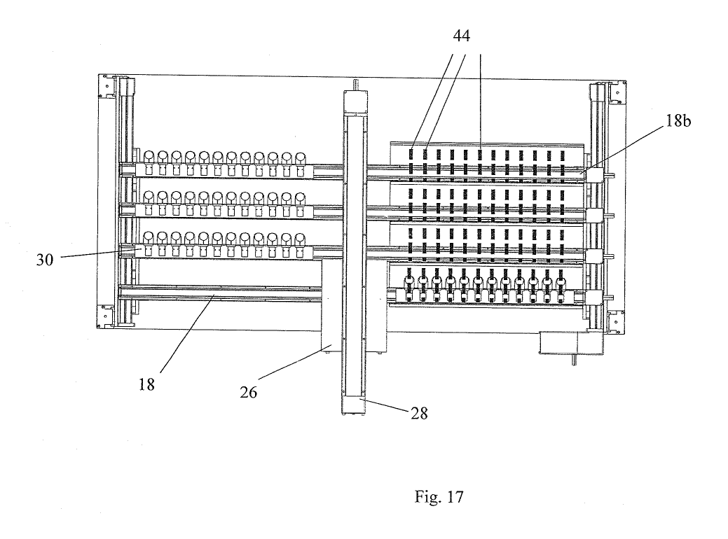

FIG. 17 shows an embodiment wherein sensors are employed to monitor the positions of the preforms at the second end 18b of the lane conveyors of the system 10.

The central control system may be employed to adjust the injection moulding parameters where the results of the optical inspection unit are consistently off the predetermined quality. As a result, the injection pressure in one or more cavities may be altered or the mould temperature may be changed to adjust the physical properties of the resulting preforms.

The use of the two-dimensional preform arrangement is advantageous because it allows a plurality of carriers to be used, which, in the present invention, allows for the visual inspection unit to be more compact by having multiple lanes and conveyors opposed to a single conveyor for all preforms to pass along.

The tool is intended to be a device that removes the preforms from an injection moulding machine. However, it should be noted that there are many ways to receive preforms from a mould and the invention is intended to include such methods. For example, the preforms may be received directly into the carrier units from the mould. In such an embodiment, it may advantageous that the carrier comprises a cooling system. In a different embodiment, there may be a plurality of tools that pass the preforms along, which may include positioning the optical inspection system remotely from the injection moulding device. During the movement of the preforms from a first location to the visual inspection unit, the two-dimensional positioning of the preforms is maintained.

The tool may move vertically towards the carrier units rather than the carrier units moving up to the tool. Alternatively, both parts may move vertically. The tool may be able to house multiple arrays of preforms, that is, each cycle of the injection moulding device creates a new array of preforms. By housing those preforms in the tool, they can be cooled and dispensed to the carrier units when required. It may be preferable for the tool to have a one-to-one relationship and have the same number of recesses to the number of preforms produced in a single run. Alternatively, the ratio may vary according to the requirements.

The tool may be employed to deliver the preforms from the injection moulding device to a plurality of optical inspection systems. For example, there may be three sets of four lane conveyors, each set of four lane conveyors being provided with an optical inspection unit. In such an arrangement, the tool delivers a first part of the array of preforms to the first set of lane conveyor carrier units, a second part of the array of preforms to the second set of lane conveyor carrier units and a third part of the array of preforms to the third set of lane conveyor carrier units. The tool is adapted to move between the three sets of lane conveyors.

The present invention may be adapted so that each of the lane conveyors is provided with its own optical inspection unit fixed adjacent the lane conveyor for inspecting the preforms of the carrier unit attached to that lane conveyor. This avoids the need for the optical inspection unit to move across the lane conveyors, thereby reducing the inspection cycle time. Alternatively, the system may comprise two or more optical inspection units that each optically inspect a carrier unit of preforms in parallel. The optical inspection units and then moved to another lane conveyor to inspect the next carrier unit of preforms. This, therefore, reduces the cycle time by inspecting multiple carrier units of preforms at in parallel. However, it is preferred that an optical inspection unit is moveable between the lane conveyors.

In one embodiment, there is provided a fixed neck and base camera for each lane conveyor and the body cameras a mounted on a moveable optical inspection unit that inspects more than one lane of preforms.

In a further embodiment, the optical inspection unit may be fixed and the lane conveyors may move relative to the optical inspection unit so that each carrier unit is presented to the fixed optical inspection unit.

Air jets may be employed on the carrier units to assist with releasing the preforms from the grippers. Once the grippers have been opened, such air jets provide a force to help to release those preforms that do not automatically release.

It is envisaged that the carrier units may comprise grippers that are all operated at the same time, rather than being individually controlled. In such an arrangement, the ejection system may be adapted so that those failing the optical inspection are rejected and removed from the process at a later time. In such an arrangement a further set of grippers may receive the preforms and sort them accordingly.

The distribution conduit may comprise a conveyor system to direct the preforms according to whether then pass or fail the inspection. It may be desirable that a conveyor is used in place of a conduit and the preforms fall directly from the carrier unit(s) onto the conveyor.

The carrier units may be arranged so that there are an equal number of carrier units to the rows of preforms in the tool. In such an arrangement, all of the preforms are inspected in a single running of the process, thereby reducing the time to inspect all of the preforms produced from one injection moulding process.

The position of the carrier unit may be determined using cameras, optical character recognition and/or use of electric pulses. Additionally, or alternatively, the system may employ servos and/or encoders mounted to each lane. Further additions or alternatives include the use of sensors mounted on each of the carrier units, preferably on the front thereof, which are incrementally triggered each time a part passes a sensor arranged on the optical inspection unit or elsewhere on the system. Another method may be to employ sensor mounted next to each preform at the ejection point (the second end of the lane conveyors) in order to ascertain which parts have been ejected as good and which ones remain after the ejection of good parts and are determined as bad.

A camera may be mounted on above the second end of the lane conveyors that is trained on the carrier units to monitor whether a preforms is present in each gripper.

To reduce the cycle time, the optical inspection system of the present invention may be arranged vertically opposed to horizontally, thus, the lane conveyors run vertically, as shown in FIG. 14. This allows the preforms to be taken from the injection moulding device directly, rather than needing to be transferred to the tool. Alternatively, the tool may be employed and the preforms transferred to the carrier units without the need for the tool to be rotated.

1. A preform optical inspection system., comprising:
a plurality of carrier units, each mounted on a respective lane conveyor for receiving preforms from an injection moulding device; and,
an optical inspection unit;
wherein the optical inspection unit is capable of transverse movement relative to the lane conveyors and the carrier units are able to pass through the optical inspection unit.

2. The preform optical inspection system according claim 1, wherein system further comprises a tool for receiving the preforms from an injection moulding device and the tool for transferring the preforms to the carrier units.

3. The preform optical inspection system according to claim 1, wherein the lane conveyors are substantially linear.

4. The preform optical inspection system according to claim 3, wherein the lane conveyors are substantially parallel to one another.

5. The preform optical inspection system according to claim 1, wherein the optical inspection unit moves substantially perpendicularly to the lane conveyors.

6. The preform optical inspection system according to claim 1, wherein the carrier units comprise a plurality of grippers for receiving and holding the preforms therein.

7. The preform optical inspection system according to claim 1, wherein the carrier units and their respective lane conveyors are attached to a vertical conveyor which is height-wise adjustable so as to permit them to be raised towards the tool to receive the preforms and lowered therefrom.

8. The preform optical inspection system according to claim 1, wherein the system further comprises a chute positioned beneath the end of the lane conveyors furthest from the tool to receive preforms from the carrier units once they have been inspected.

9. The preform optical inspection system according to claim 8, wherein the chute has a first conduit and a second conduit to direct the inspected preforms accordingly.

10. preform optical inspection system according to claim 1, wherein the system further comprises a monitoring device to monitor the position of each carrier unit.

11. The preform optical inspection system according to claim 10, wherein the monitoring device comprises a system selected from a group comprising: a servomotor; an encoder; a camera; and a plurality of detectable items positioned along the length of the carrier units and a detector mounted adjacent the lane conveyor.

12. A method of optically inspecting a plurality of preforms, comprising the steps of:
providing a plurality of carrier units each connected to a respective lane conveyor, the carrier units adjacent an injection molding device, the injection molding device for dispensing a plurality of preforms in a two-dimensional array;
providing an optical inspection unit adjacent the lane conveyors;
receiving the preforms from the injection molding device and transferring the preforms into the carrier units;
moving a first of the carrier units along its respective lane conveyor and passing it through the optical inspection unit;
moving the optical inspection unit to a second lane conveyor and passing a second of the carrier units therethrough;
ejecting a first group of preforms from the carrier units after the performs have been inspected; and
ejecting a second group of preforms from the carrier units.

13. The method according to claim 12, wherein the lane conveyors are linear and substantially parallel with one another and the optical inspection unit moves substantially perpendicular to the lane conveyors.

14. The method according to claim 12, wherein the performs are received directly in the carrier units from the injection molding device.

15. The method according to claim 12, wherein the position of the carrier units on its respective lane conveyor is monitored to track when each preform passes through the optical inspection unit in order to identify the preform of the two-dimensional array being inspected.

16. The method according to claim 15, wherein the result of the optical inspection of each preform is logged and one of the groups of preforms ejected from the carrier units comprises those preforms that have passed predetermined inspection criteria and the other group of preforms ejected from the carrier units comprises those performs that fail to pass the predetermined inspection criteria.

17. The method according to claim 15, wherein data from the optical inspection unit is recorded during the optical inspection of each preform and that data is transferred to an injection molding device control system, and wherein the control system adjusts process parameters based on the data received to correct any faults in the corresponding injection molding device cavity.

18. The method according to claim 12, wherein either: the performs are received in the carrier units via a tool which maintains the two-dimensional array created by the injection molding device into the adjacent carrier units.
